(19) United States
(12) Patent Application Publication
(10) Pub. No.: US 2018/0269571 A1
(43) Pub. Date: Sep. 20, 2018

(54) ANTENNA DEVICE AND GROUND CONNECTION STRUCTURE

(71) Applicant: DENSO WAVE INCORPORATED, Chita-gun (JP)

(72) Inventor: Yosuke HIRAIWA, Chita-gun (JP)

(73) Assignee: DENSO WAVE INCORPORATED, Chita-gun (JP)

(21) Appl. No.: 15/915,004

(22) Filed: Mar. 7, 2018

(30) Foreign Application Priority Data
Mar. 15, 2017 (JP) 2017-049862
Mar. 15, 2017 (JP) 2017-049863

(51) Int. Cl. H01Q 1/48; H01Q 9/04

(52) U.S. Cl. CPC H01Q 1/48; H01Q 1/243; H01Q 9/0414; H01Q 9/0421

(57) ABSTRACT

An antenna device includes first and second folded antenna elements connected to first and second perpendicular sides of a ground at first and second connection points, respectively. The first and second sides have lengths Gx and Gy shorter than or equal to half the signal wavelength λ. Gx1 is defined as a length of a portion of the first side between the first connection point and an end of the first side away from the first folded antenna element in a direction opposite to a folding direction thereof. Gy1 is defined as a length of a portion of the second side between the second connection point and an end of the second side away from the second folded antenna element in a direction opposite to a folding direction thereof. The Gx1 and Gy1 satisfy inequalities: 0≤Gx1<Gx/2 and 0≤Gy1<Gy/2.

### CROSS REFERENCE TO RELATED APPLICATIONS

This application is based on and incorporates herein by reference Japanese Patent Applications No. 2017-049862 filed on Mar. 15, 2017, and No. 2017-049863 filed on Mar. 15, 2017.

### TECHNICAL FIELD

The present disclosure relates to an antenna device and a ground connection structure.

### BACKGROUND

When an inverted-F antenna which is a type of a folded antenna is connected to a side of a ground, the inverted-F antenna is generally connected to a center of the side of the ground. As disclosed by Patent Literature (e.g. JP 2013-93645 A), the inverted-F antenna may be connected to a position displaced from the center of the side of the ground.

### SUMMARY

When an antenna device having two antenna elements disposed on two sides of a ground is used as a receiver antenna, directivities of the two antenna elements may be set to be independent from each other in order to ensure diversity in a reception condition.

However, as shown in FIG. 17, when two inverted-F antenna elements are connected to centers of two sides of a ground, it is found that both of main beams of the antenna elements may be inclined at an approximately 45-degree angle from a horizontal direction and may be approximately parallel to each other. Thus, in this case, the diversity cannot be ensured.

Generally, the antenna device is used in a state connected to a communication circuit. Thus, the ground of the antenna device is connected to a circuit ground. When the ground of the antenna device is connected to a circuit ground, a whole shape of the ground is changed, and directivity of the antenna device may be affected.

It is an object of at least one embodiment of the present disclosure is to provide an antenna device capable of separating directions of main beams of two folded antenna elements.

It is another object of at least one embodiment of the present disclosure is to provide a ground connection structure of an antenna device in which a circuit ground can be connected to an antenna ground with keeping original directivity of the antenna device.

According to at least one embodiment of the present disclosure, an antenna device includes a ground, and first and second folded antenna elements. The ground has a first side which has a length Gx, and a second side which has a length Gy and is perpendicular to the first side. Each of the lengths Gx and Gy is smaller than or equal to λ/2 when a signal wavelength is defined as λ. A first folded antenna element is connected to the first side of the ground at a first connection point and has a first folded element portion folded in a first folding direction. The second folded antenna element is connected to the second side of the ground at a second connection point and has a second folded element portion folded in a second folding direction. Gx1 is defined as a length of a portion of the first side between the first connection point and an end of the first side away from the first folded element portion in a direction opposite to the first folding direction. The length Gx1 satisfies inequalities: 0≤Gx1<Gx/2. Gy1 is defined as a length of a portion of the second side between the second connection point and an end of the second side away from the second folded element portion in a direction opposite to the second folding direction. The length Gy1 satisfies inequalities: 0≤Gy1<Gy/2.

According to at least one embodiment of the present disclosure, a ground connection structure includes an antenna device, a circuit ground and a connector connecting the antenna ground and the circuit ground. The antenna device includes an antenna ground, and first and second folded antenna elements. The antenna ground has a first side which has a length Gx, and a second side which has a length Gy and is perpendicular to the first side. Each of the lengths Gx and Gy is smaller than or equal to λ/2 when a signal wavelength is defined as λ. The first folded antenna element is connected to the first side of the antenna ground at a first connection point and has a first folded element portion folded in a first folding direction. The second folded antenna element is connected to the second side of the antenna ground at a second connection point and has a second folded element portion folded in a second folding direction. Gx1 is defined as a length of a portion of the first side between the first connection point and an end of the first side away from the first folded element portion in a direction opposite to the first folding direction. The length Gx1 satisfies inequalities: 0≤Gx1<Gx/2. Gy1 is defined as a length of a portion of the second side between the second connection point and an end of the second side away from the second folded element portion in a direction opposite to the second folding direction. The length Gy1 satisfies inequalities: 0≤Gy1<Gy/2. The circuit ground has a rectangular shape having a short side and a long side, and the short side and one of the first and second sides are aligned while the long side faces the antenna ground. The connector extends from a side of the circuit ground opposite from the short side, extends parallel to a third side of the antenna ground opposite from the one of the first and second sides, and is connected to a center part of the third side of the antenna ground.

According to at least one embodiment of the present disclosure, a ground connection structure includes an antenna device, a circuit ground and a connector connecting the antenna ground and the circuit ground. The antenna device includes an antenna ground and first and second folded antenna elements. The antenna ground has a first side which has a length Gx, and a second side which has a length Gy and is perpendicular to the first side. Each of the lengths Gx and Gy is smaller than or equal to λ/2 when a signal wavelength is defined as λ. The first folded antenna element is connected to the first side of the antenna ground. The second folded antenna element is connected to the second side of the antenna ground. The connector extends from a part of the circuit ground that does not face the antenna ground, and is connected to a center part of a third side of the antenna ground opposite from one of the first and second sides of the antenna ground.

### BRIEF DESCRIPTION OF THE DRAWINGS

The disclosure, together with additional objectives, features and advantages thereof, will be best understood from the following description, the appended claims and the accompanying drawings, in which:

FIG. 1 is a diagram illustrating an antenna device according to at least one embodiment;

FIG. 2 is a diagram illustrating current flows in the antenna device;

FIG. 3 is a diagram illustrating directivity of a first antenna element of the antenna device;

FIG. 4 is a diagram illustrating directivity of a second antenna element of the antenna device:

FIG. 5 is a diagram illustrating an antenna device according to at least one embodiment;

FIG. 6 is a diagram illustrating an antenna device according to at least one embodiment;

FIG. 7 is a diagram illustrating an antenna device according to at least one embodiment;

FIG. 8 is a diagram illustrating an antenna device including a single antenna element, according to at least one embodiment;

FIG. 9 is a diagram illustrating an antenna device including a single antenna element, according to at least one embodiment;

FIG. 10 is a diagram illustrating an antenna device including a single antenna element, according to a comparative example;

FIG. 11 is a diagram illustrating change in direction of main beam of an antenna element from the configuration of FIG. 8 to the configuration of FIG. 10;

FIG. 12 is a diagram illustrating change in direction of main beam of the antenna element in accordance with a connection point between the antenna element and a ground;

FIG. 13 is a diagram illustrating a current flow in the antenna device of FIG. 10;

FIG. 14 is a diagram illustrating a simulation result of radio emission of the antenna device of FIG. 10;

FIG. 15 is a diagram illustrating a current flow in the antenna device of FIG. 8;

FIG. 16 is a diagram illustrating a simulation result of radio emission of the antenna device of FIG. 8;

FIG. 17 is a diagram illustrating an antenna device according to a comparative example;

FIG. 18 is a diagram illustrating a connection state of a ground of an antenna device and a circuit ground with directivity in x-y plane, according to at least one embodiment;

FIG. 19 is a diagram illustrating a pattern of directivity in x-z plane;

FIG. 20 is a diagram illustrating another connection state of a ground of an antenna device and a circuit ground with directivity in x-y plane, according to at least one embodiment;

FIG. 21 is a diagram illustrating a pattern of directivity in x-z plane;

FIG. 22 is a diagram illustrating an antenna device with directivity in x-y plane, according to at least one embodiment;

FIG. 23 is a diagram illustrating a pattern of directivity in x-z plane;

FIG. 24 is a schematic diagram illustrating current flows in an antenna device;

FIG. 25 is a schematic diagram illustrating current flows in a configuration corresponding to FIG. 20;

FIG. 26 is a schematic diagram illustrating current flows in another connection configuration different from FIG. 20; and

FIG. 27 is a schematic diagram illustrating current flows in a configuration corresponding to FIG. 18.

### DETAILED DESCRIPTION

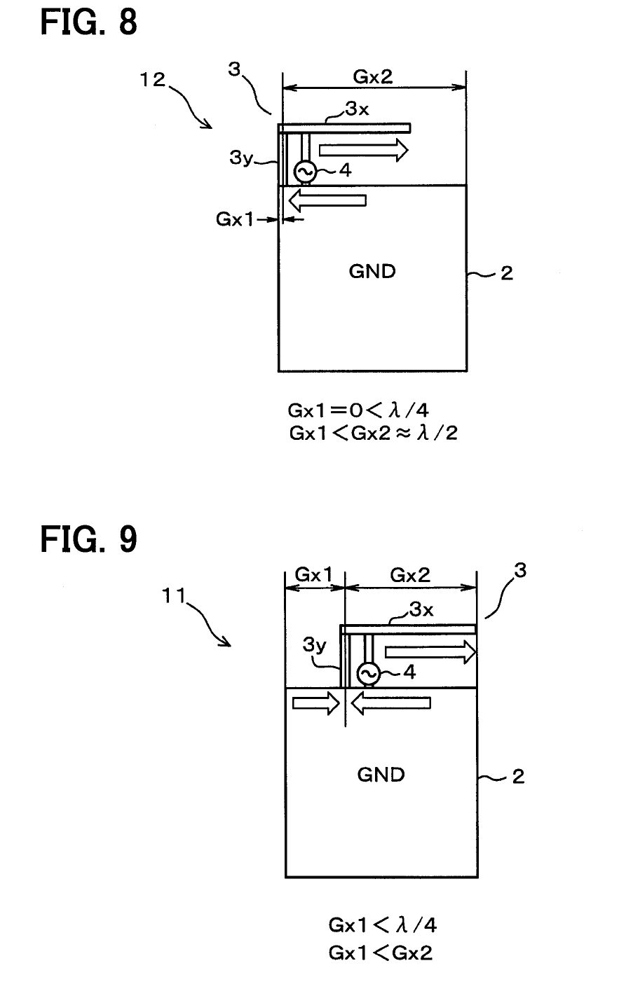

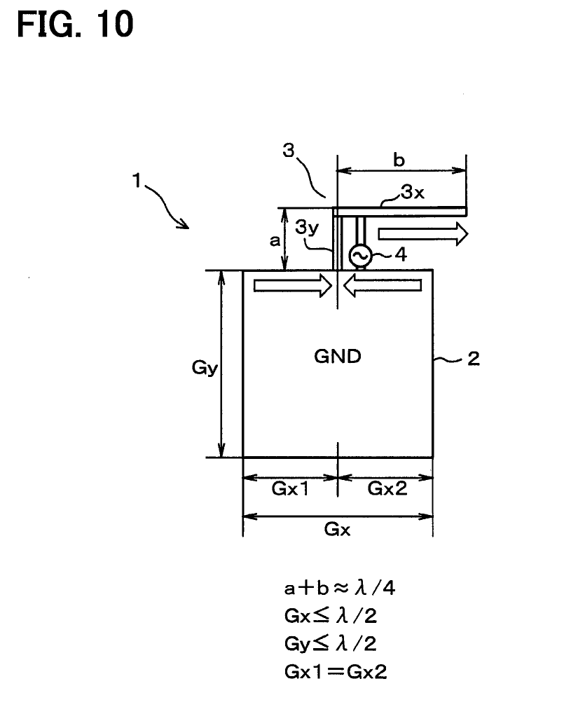

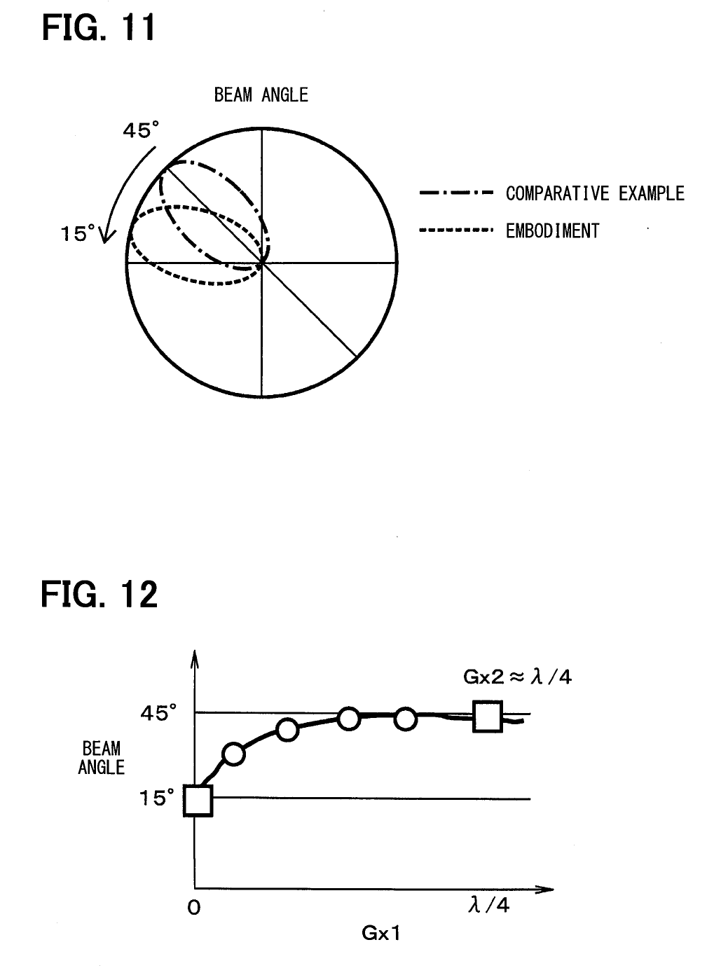

Embodiments will be described with reference to the drawings. First, a configuration of an antenna device including a single antenna element will be described with reference to FIGS. 8 to 16. An antenna device 1 shown in FIG. 10 includes a ground 2 having a square shape and formed by, for example, a wiring pattern on a dielectric substrate which is not shown in the drawings, and an antenna element 3 connected to the ground 2. In the drawings, a length of the ground 2 in a horizontal direction is defined as Gx, a length of the ground 2 in a vertical direction is defined as Gy, and a wavelength of a communication signal is defined as λ. Gx and Gy satisfy the inequalities: Gx≤λ/2, and Gy≤λ/2. The wavelength λ is expressed by λ=λ0/√ϵ, where λ0 is the wavelength of light, and √ϵ is a dielectric constant of the dielectric substrate.

The antenna element 3 is an inversed-F antenna which is a type of a folded antenna. The antenna element 3 includes a vertical element portion 3y and a horizontal element portion 3x. The antenna element 3 may consist of the vertical element portion 3y and the horizontal element portion 3x. The horizontal element portion 3x is connected to the ground 2 through the vertical element portion 3y. The horizontal element portion 3x is connected to the ground 2 through a feeding point 4. The horizontal element portion 3x may be directly connected to the vertical element portion 3y. The horizontal element portion 3y may be directly connected to the ground 2. When a length of the vertical element portion 3y is defined as a, and a length of the horizontal element portion 3x is defined as b, the length of the antenna element 3, which is (a+b), is set to be approximately equal to λ/4. The length b of the horizontal element portion 3x may satisfy inequalities: λ/8<b<λ/4. The horizontal element portion 3x may be an example of a first folded element portion folded in a first folding direction, and may be folded to extend parallel to a first side of the ground 2 to which the antenna element 3 is connected. The vertical element portion 3y may be an example of a first portion of the antenna element 3 extending from a first side of the ground 2 in a first direction. The horizontal element portion 3x may be an example of a second portion of the antenna element 3 extending from the first portion in a second direction different from the first direction.

A first connection point at which the vertical element portion 3y of the antenna element 3 is connected to a side of the ground 2 is defined as Gx1 when a left end of the side is used as a reference (i.e. zero). In other words, Gx1 can be defined as a length of a portion of the side of the ground 2 between the first connection point and the left end. Similarly, Gx2 can be defined as a length of a portion of the side of the ground 2 between the first connection point and a right end of the side. Therefore, Gx satisfies the equality: Gx=Gx1+Gx2. In the antenna device 1 of the comparative example, the vertical element portion 3y is connected to a center of the side of the ground 2, which means Gx1=Gx2=λ/2.

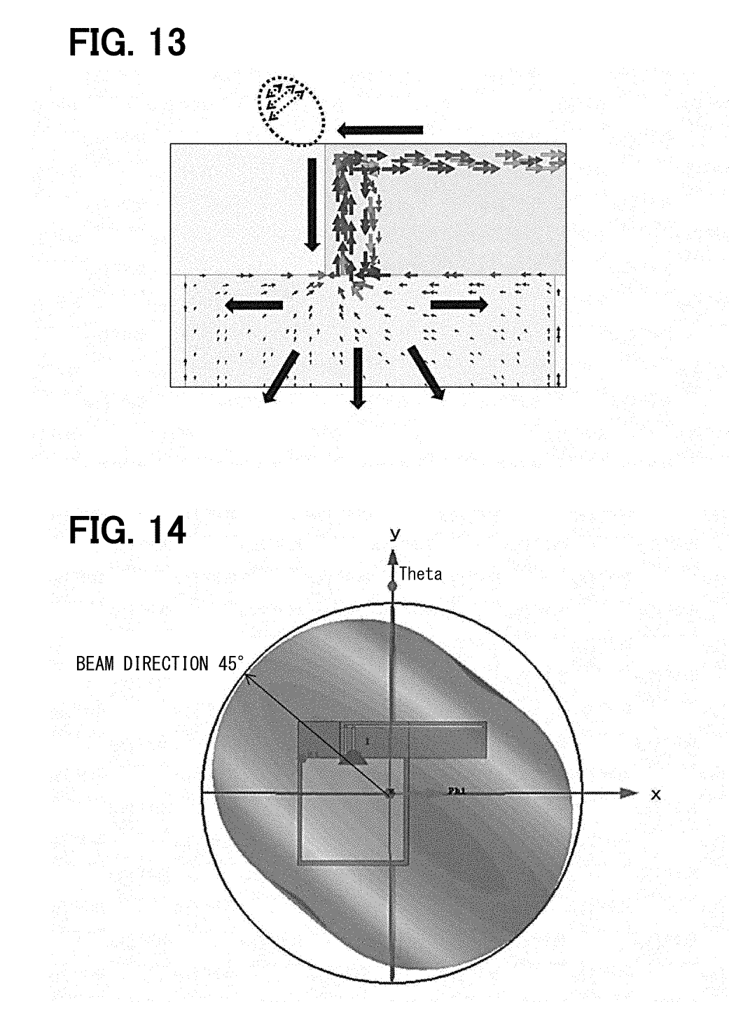

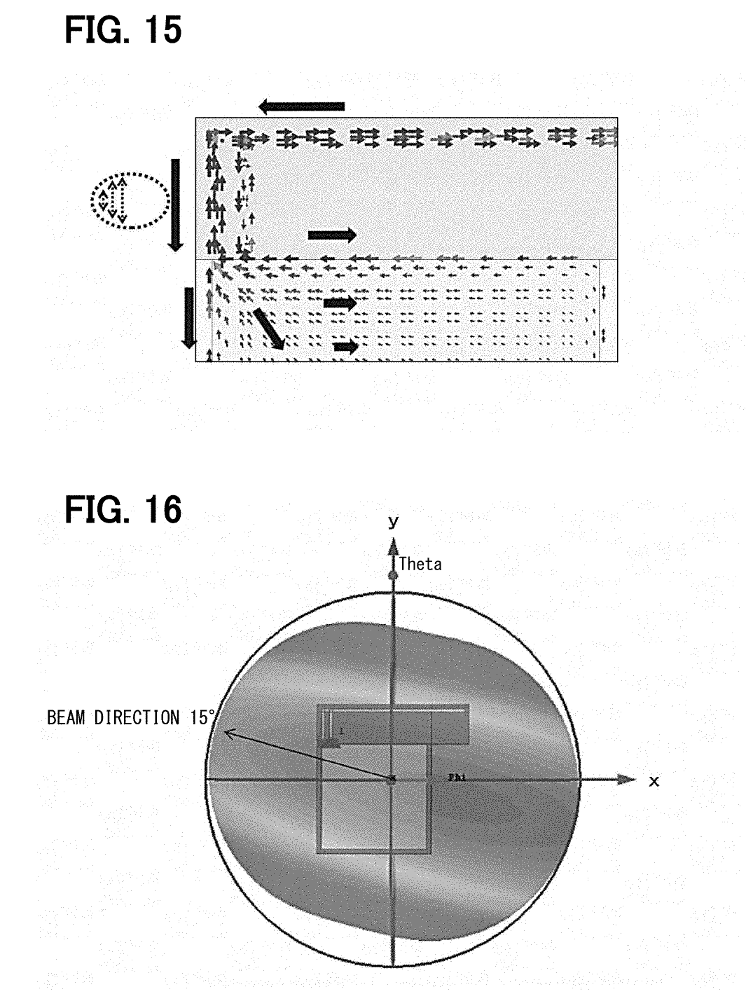

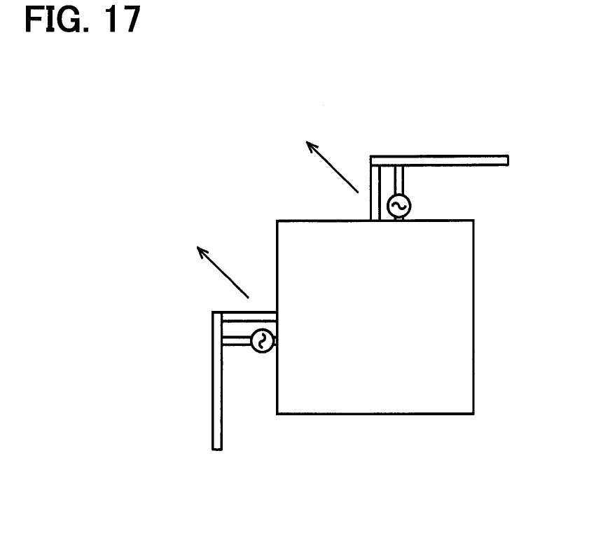

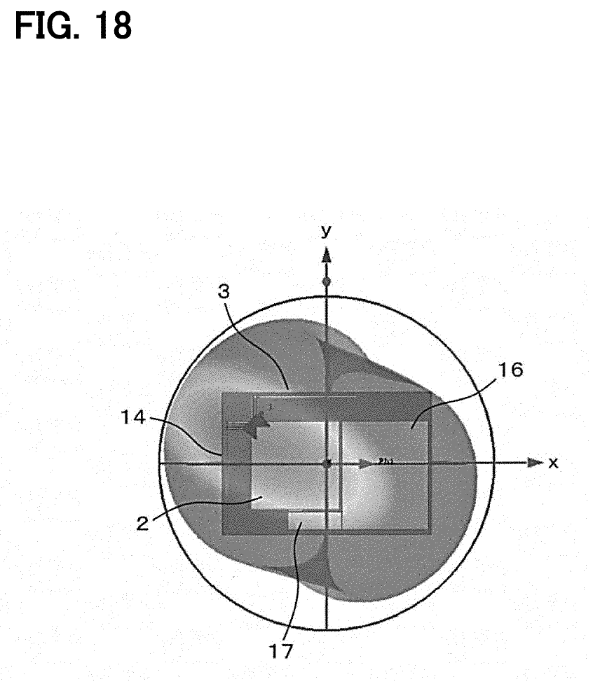

In the comparative example, simulation results of current flow in the antenna element 3 and the ground 2 during communication of the antenna device 1 are shown in FIG. 13. Large arrows in FIGS. 13 and 15 represent current flows which are opposite to flows represented by small arrows in a manner of alternate current. A current flow in the horizontal element portion 3x of the antenna element 3 and a current flow in a side portion of the ground 2 that faces the horizontal element portion 3x are opposite in flow direction and cancel each other out.

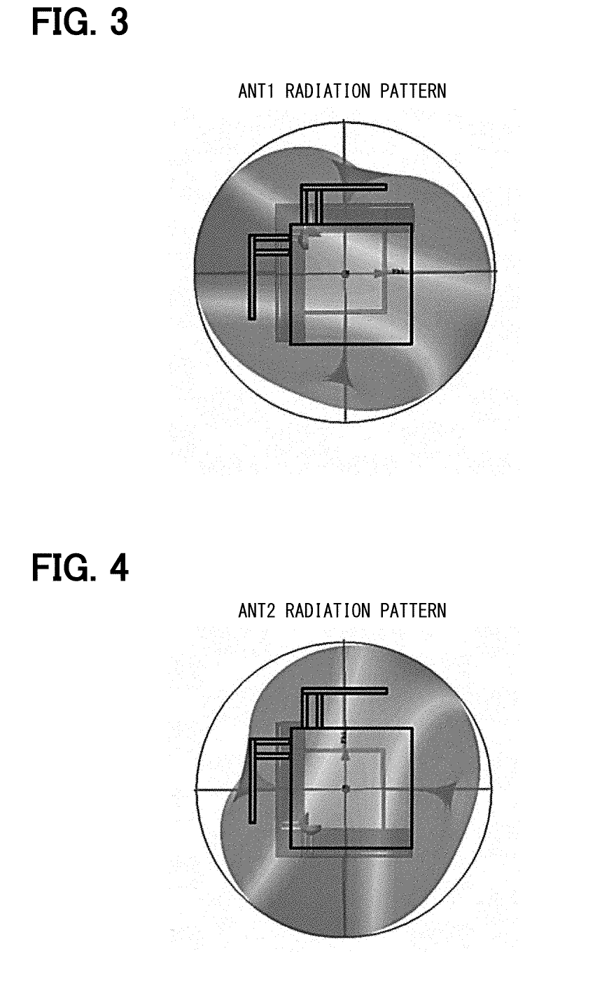

When the vertical element portion 3y is connected to the center of the side of the ground 2, a current flows also in a left portion of the ground 2 in FIG. 3 that does not face the horizontal element portion 3x. Consequently, the current flow in the horizontal element portion 3x may not be cancelled sufficiently, and thereby causes a vertically polarized wave component. A current flow in the vertical element portion 3y causes a horizontally polarized wave component. As a result of combination of the polarized wave components caused by the current flows in the horizontal element portion 3x and the vertical element portion 3y, a main beam of the antenna device 1 is upward and inclined at 45-degree angle from the horizontal direction as shown by dashed arrows in FIG. 6.

When the vertical element portion 3y is connected to the center of the side of the ground 2, a current flows also in a left portion of the ground 2 in FIG. 3 that does not face the horizontal element portion 3x. Consequently, the current flow in the horizontal element portion 3x may not be cancelled sufficiently, and thereby causes a radio wave component along a direction inclined at approximately 90-degree angle from the horizontal direction. A current flow in the vertical element portion 3y causes a radio wave component along a direction inclined at approximately 0-degree angle from the horizontal direction. As a result of combination of the radio wave components caused by the current flows in the horizontal element portion 3x and the vertical element portion 3y, a main beam of the antenna device 1 is upward and inclined at 45-degree angle from the horizontal direction as shown by dashed arrows in FIG. 13.

FIG. 14 is a simulation result of radio emission of the antenna device 1 corresponding to the state of FIG. 13 and shows that the beam direction is upward and inclined at 45-degree angle from x-axis that corresponds to the horizontal direction.

According to an antenna device 11 of an embodiment, as shown in FIG. 9, the connection point Gx1 of the vertical element portion 3y is set to satisfy the inequalities: Gx1<λ/4, and Gx1<Gx2. That is, the connection point Gx1 is between the center and the reference left end of the side. Alternatively, as shown in FIG. 8, in an antenna device 12, the connection point Gx1 may be on the left end, i.e. Gx1=0. For the antenna device 12, as shown in FIG. 15, the current flow in the horizontal element portion 3x can be sufficiently cancelled by the current flow in the side portion of the ground 2. Therefore, the vertically polarized wave component, i.e. the radio wave component along the direction inclined at approximately 90-degree angle from the horizontal direction can be reduced effectively. As a result, a main beam of the antenna device 12 is upward and inclined at 15-degree angle from the horizontal direction, as shown by dashed arrows in FIG. 15.

FIG. 16 is a simulation result of radio emission of the antenna device 12 corresponding to the state of FIG. 15 and shows that the beam direction is upward and inclined at 15-degree angle from the horizontal direction, as described above.

Based on the results shown in FIGS. 14 and 16, a main beam of the antenna device 11 of FIG. 9 is expected to be inclined at between 45-degree and 15-degree angle from the horizontal direction, as shown by plots “∘” in FIG. 12.

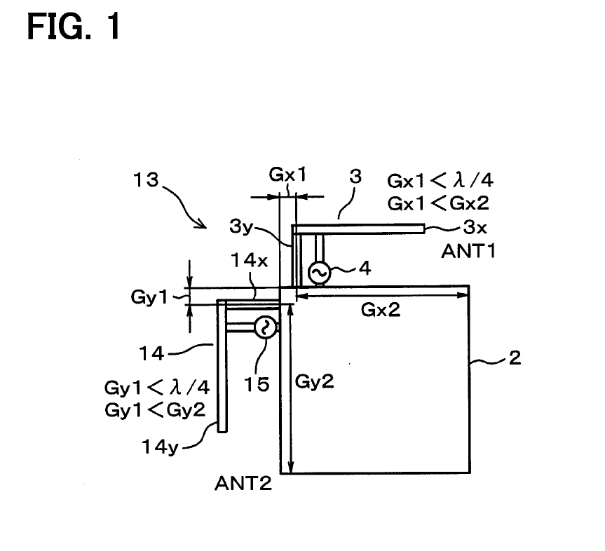

An antenna device 13 of an embodiment is, as shown in FIG. 1, obtained by adding another inverted-F antenna element 14 to the antenna device 11 shown in FIG. 9. In the antenna device 13, the connection point Gx1 is displaced to be closer to the reference end than that of FIG. 9, which means Gx1 satisfies an inequality: Gx1<Gx/4, i.e. Gx1<λ/8. The antenna elements 3 and 14 are referred to as a first antenna element 3 and a second antenna element 14, respectively. The second antenna element 14 is disposed on a second side, i.e. left side, of the ground in the drawings, and the second side is perpendicular to a first side of the ground on which the first antenna element 3 is disposed. In the second antenna element 14, a vertical element portion 14y is connected to the ground 2 through a horizontal element portion 14x. The vertical element portion 14y is connected to the ground 2 through a feeding point 15. The vertical element portion 14y may be directly connected to the horizontal element portion 14x. The horizontal element portion 14x may be directly connected to the ground 2. A total length, i.e. (c+d) of the vertical element portion 14y and the horizontal element portion 14x is approximately λ/4, similar to the first antenna element 3. The length c of the vertical element portion 14y may satisfy inequalities: λ/8<c<λ/4. The vertical element portion 14y may be an example of a second folded element portion folded in a second folding direction, and may be folded to extend parallel to a second side of the antenna ground 2 to which the antenna element 14 is connected. The horizontal element portion 14x may be an example of a third portion of the antenna element 14 extending from a second side of the ground 2 in a third direction. The vertical element portion 14y may be an example of a fourth portion of the antenna element 14 extending from the third portion in a fourth direction different from the third direction.

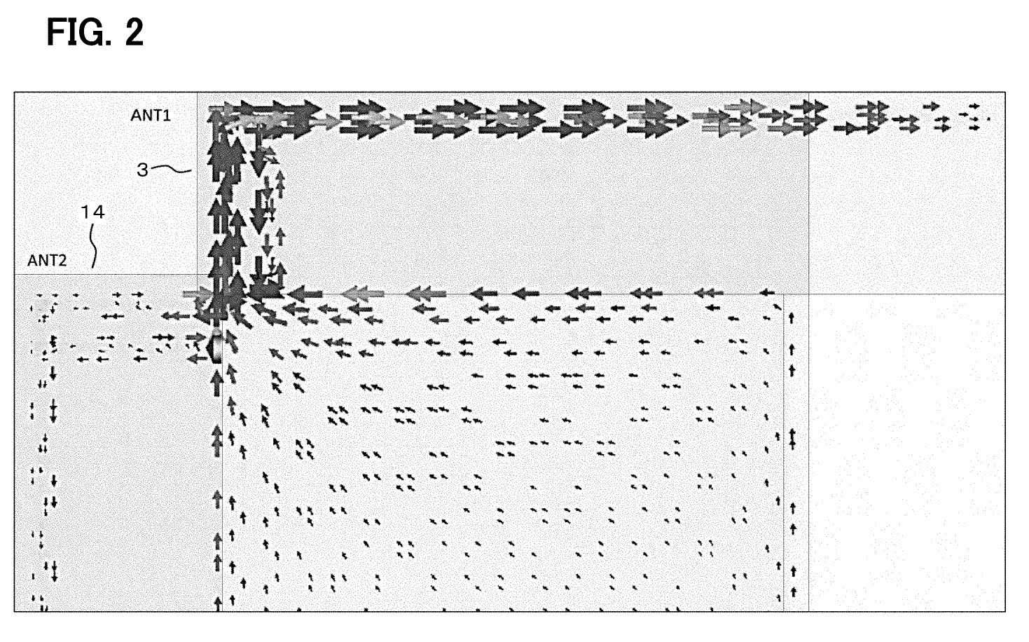

A second connection point Gy1 of the horizontal element portion 14x is, similar to the first antenna element 3, displaced from a center of the second side toward a reference position, i.e. an upper end of the second side, which means Gy1 satisfies an inequality: Gy1<Gy/4. As described above, the first antenna element 3 is disposed on the first side, and the second antenna element 14 is disposed on the second side that is perpendicular to the first side. Hence, as shown by a current flow model in FIG. 2, a mutual influence of the first and second antenna elements 3 and 14 reduces. As a result, a main beam of the first antenna element 3 (ANT1) is upward and inclined at approximately 15-degree angle from the horizontal direction as shown in FIG. 3, and a main beam of the second antenna element 14 (ANT2) is inclined clockwise at approximately 15-degree angle from the vertical direction as shown in FIG. 4. In other words, the main beams of the first and second antenna elements 3 and 14 cross each other at right angles. The current flow model of FIG. 2 is obtained in a condition where Gx1=Gy1=0.

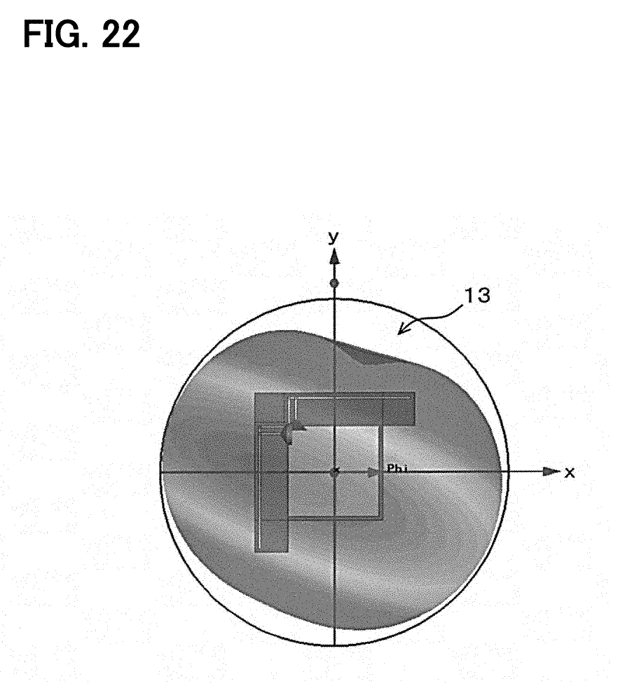

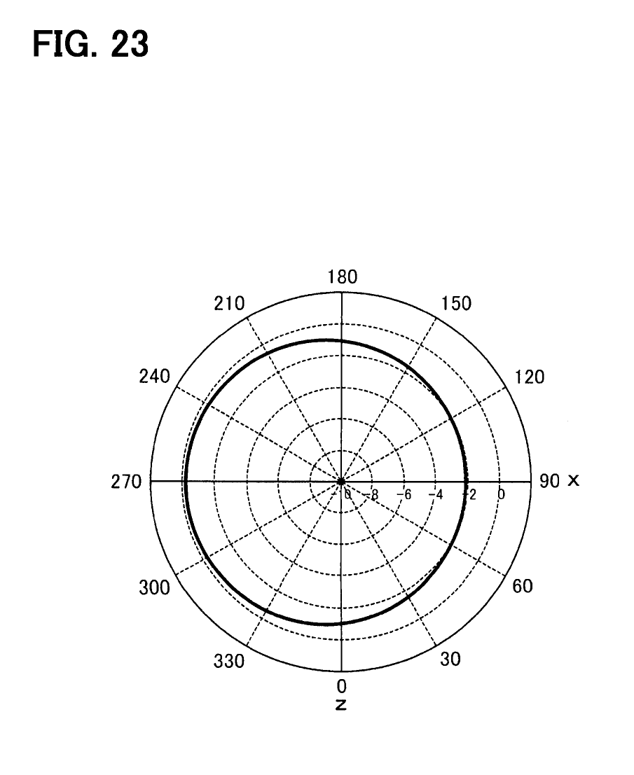

In at least one embodiment, a circuit ground is connected to the ground 2 of the antenna device 13. Hereinafter, the ground 2 may be referred to as an antenna ground 2. FIG. 22 shows a pattern of directivity of only the antenna device 13 in a vertical plane, and FIG. 23 shows a pattern of directivity in a horizontal plane. In FIG. 22, the connection point Gx1 satisfies equalities: Gx1=Gy1=0. FIG. 22 shows an x-y plane, and FIG. 23 corresponds to an x-z plane.

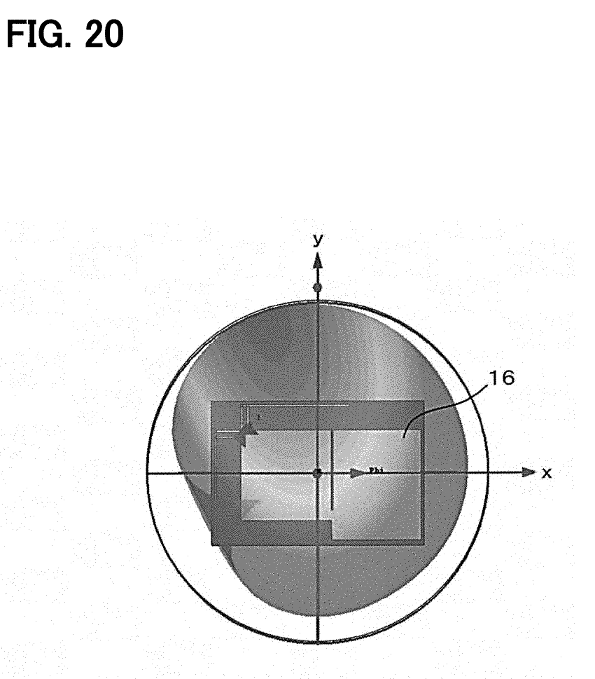

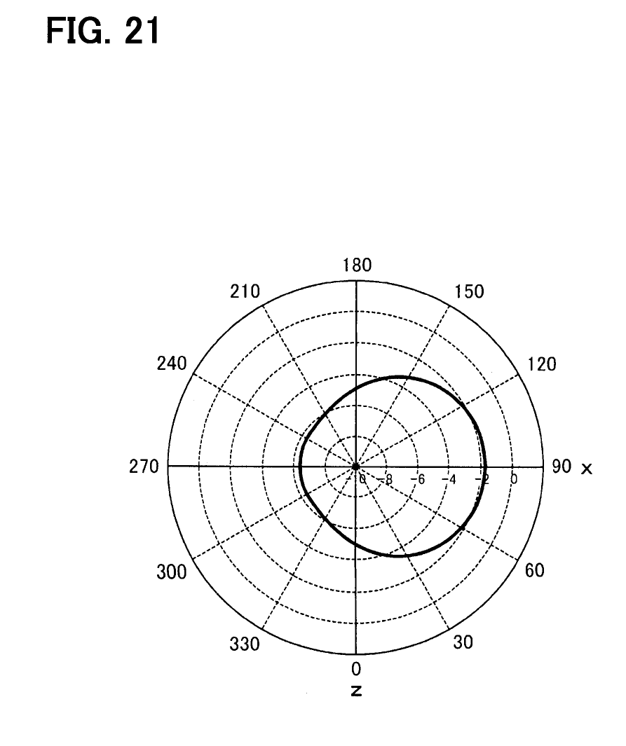

In FIG. 20, the circuit ground 16 is connected to the antenna ground 2. The circuit ground 16 is provided with a communication circuit. The circuit ground 16 has a rectangular shape having a short side and a long side. The short side has a length approximately equal to Gx, and the long side is longer than Gx. The circuit ground 16 is disposed such that the short side is set as an upper side to be the same position as an upper side of the antenna ground 2 while the long side faces the antenna ground 2. The short side of the circuit ground 16 is aligned with one of the first and second sides of the antenna ground. The antenna ground 2 and the circuit ground 16 are connected to each other at a lower right corner of the antenna ground 2. In this case, the main beam of the antenna device 13 is upward and inclined by approximately 80-degree angle from the horizontal direction. The pattern of directivity in the horizontal plane shown in FIG. 21 shows a concentration of radio energy in a 90-degree direction.

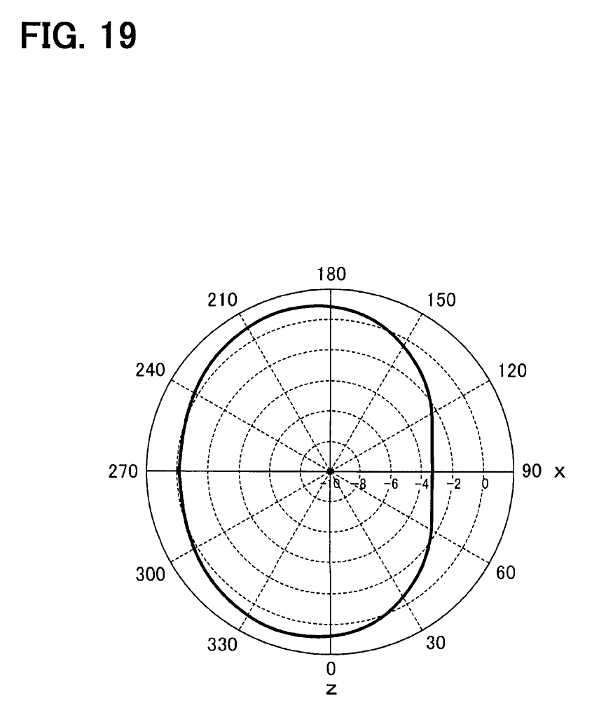

In contrast, a ground connection structure of at least one embodiment is shown in FIG. 18. A connector 17 extends from a lower side of the circuit ground 16 that is a side of the circuit ground opposite from the upper side of the circuit ground 16. The connector 17 extends parallel to a lower side of the antenna ground 2 that is a third side of the antenna ground 2 opposite from the upper side of the antenna ground 2. The connector 17 is connected to a center portion of the lower side of the antenna ground 2. Accordingly, an angle between the main beam and the horizontal direction is approximately equal to that of the antenna device 13 shown in FIG. 22. A pattern of directivity in the horizontal plane shown in FIG. 19 is near to the pattern shown in FIG. 23.

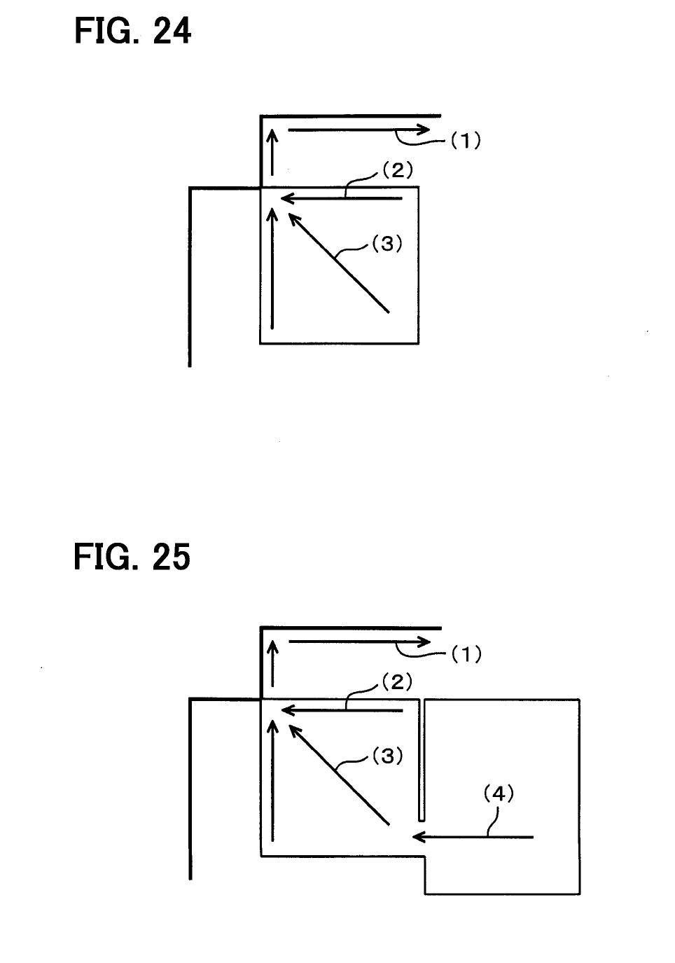

Next, with respect to respective configurations of FIGS. 22, 20 and 18, causes for differences in directivity therebetween will be described. As shown in FIG. 24, when the antenna element 3 carries a current flow (1) along directions shown in the drawings, the antenna ground 2 carries current flows (2) and (3). Since the current flow (1) is opposite in direction from and cancelled out by the current flows (2) and (3), the main beam direction becomes near to the horizontal direction as described above.

When the circuit ground 16 is connected to the antenna ground 2 as shown in FIG. 20, a current flow (4) from the circuit ground 16 to the antenna ground (2) occurs as shown in FIG. 25. There is no current flow component cancelling out the current flow (4), and thus the directivity of the antenna device 13 may be changed.

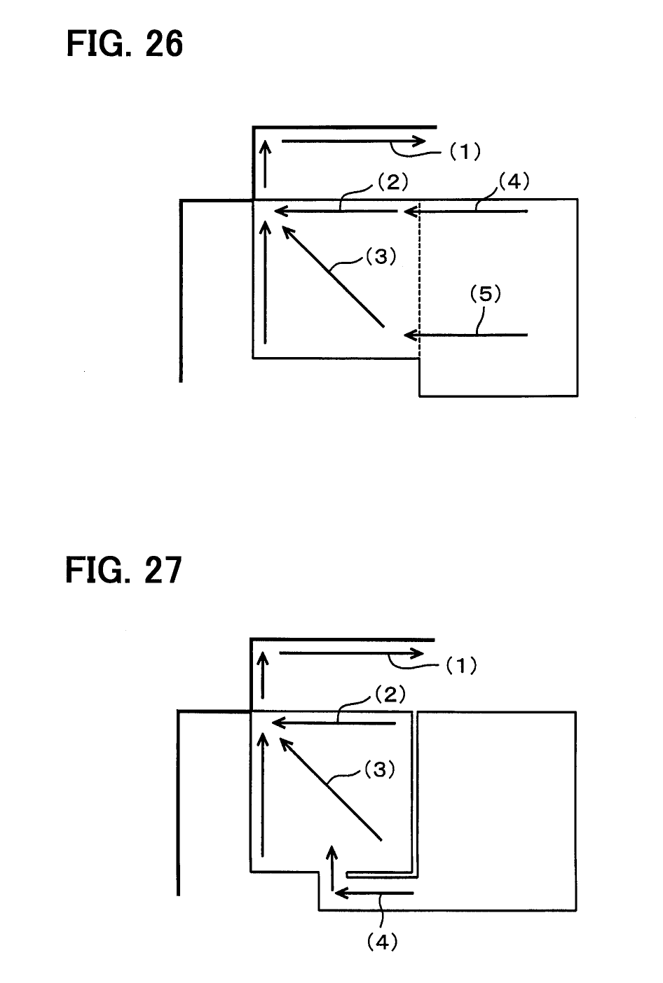

As shown in FIG. 26, when a side of the antenna ground and a side of the circuit ground 16 facing each other contact each other, current flows (4) and (5) from the circuit ground 16 to the antenna ground (2) may be generated. However, there is no current flow component cancelling the generated current flows.

In contrast, according the connection structure of at least one embodiment, as shown in FIG. 27, a current flow (4) enters the antenna ground 2 from the lower side of the antenna ground 2 with getting around a lateral side of the antenna ground 2. Though there is no current flow component cancelling the current flow (4), the current flow (4) may affect very little the directivity of the antenna device 13.

According to the embodiments, the first antenna element 3 is connected at the first connection point Gx1 to the square-shaped ground 2 including the first and second sides having the lengths Gx and Gy which are smaller than or equal to λ/2. The first connection point Gx1 satisfy inequalities: 0≤Gx1<Gx/2, when an end of the first side located away from the first connection point Gx1 in a direction opposite to an extending direction of the horizontal element portion 3x from the vertical element portion 3y is defined as a reference (i.e. zero). In other words, Gx1 can be defined as a length of a portion of the first side of the ground 2 between the first connection point and the end of the first side away from the horizontal element portion 3x in the direction opposite to the first folding direction of the horizontal element portion 3x, and Gx1 satisfies the inequalities: 0≤Gx1<Gx/2. The second antenna element 14 is connected to the ground 2 at the second connection point Gy1, and the second connection point Gy1 satisfy inequalities: 0≤Gy1<Gy/2, when an end of the second side located away from the second connection point Gy1 in a direction opposite to an extending direction of the vertical element portion 14y from the horizontal element portion 14y is defined as a reference (i.e. zero). In other words, Gy1 can be defined as a length of a portion of the second side of the ground 2 between the second connection point and the end of the second side away from the vertical element portion 14y in the direction opposite to the second folding direction of the vertical element portion 14y, and Gy1 satisfies the inequalities: 0≤Gy1<Gy/2.

Since the connection point Gx1 is displaced from the center of the first side toward the reference end, a current flow in the horizontal element portion 3x of the first antenna element 3 can be sufficiently cancelled out by a current flow in the ground 2. Also, since the connection point Gy1 is displaced from the center of the second side toward the reference end, a current flow in the vertical element portion 14y of the second antenna element 14 can be sufficiently cancelled out by a current flow in the ground 2. In addition, since the first antenna element 3 and the second antenna element 14 are disposed to have a positional relationship perpendicular to each other, the first and second antenna elements 3 and 14 can be separated, and the directions of main beams of the antenna elements 3 and 14 can be made to be perpendicular to each other. As a result, diversity of the antenna device 13 can be ensured when receiving signals.

In addition, according to at least one embodiment, the circuit ground 16 is connected to the antenna ground 2 as follows. When the first side of the antenna ground 2 is set as an upper side, the short side of the circuit ground 16 as an upper side is aligned with the upper side of the antenna ground 2 so as to be located at the same height. Further, the circuit ground 16 is disposed such that the long side of the circuit ground 16 faces the antenna ground 2. The connecter 7 extends from the lower side of the circuit ground 16, and extends parallel to the lower side of the antenna ground 2. The connector 7 is connected to the center portion of the lower side of the antenna ground 2. Accordingly, influence of a component of current flowing in or out of the antenna ground 2 through the connector 7 on a current distribution in the antenna device 13 can be reduced. As a result, separation between the first antenna element 3 and the second antenna element 14 can be kept, and changes in their directivities can be reduced.

Furthermore, as shown in FIG. 2, when the connection points Gx1 and Gy1 satisfy the equalities: Gx1=Gy1=0, the directions of main beams of the first and second antenna elements 3 and 14 can be further effectively made to be perpendicular to each other.

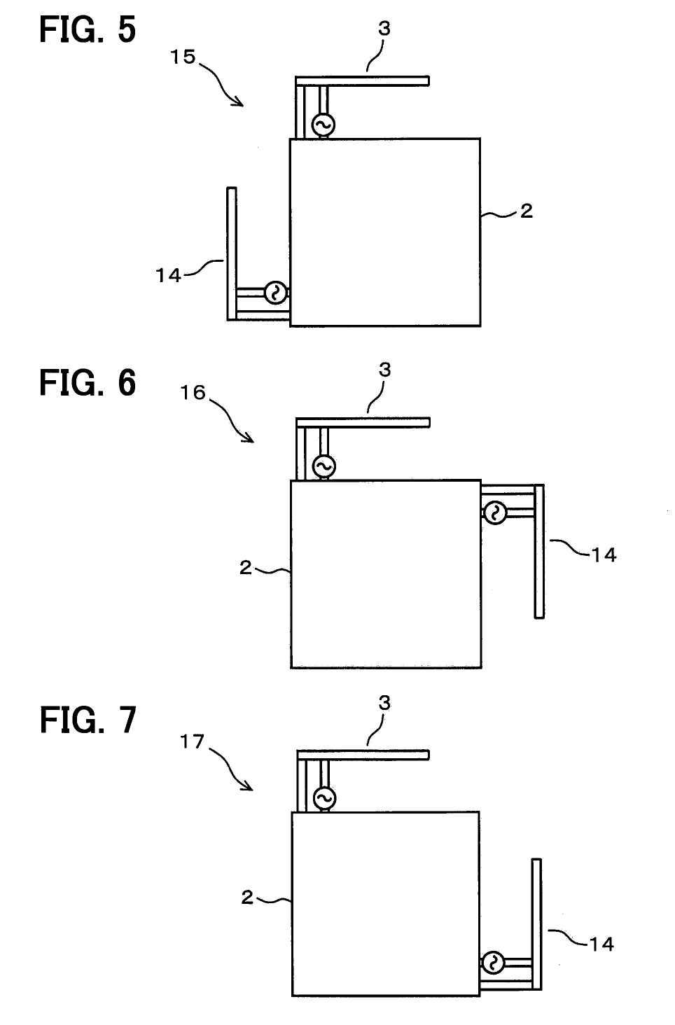

FIGS. 5 to 7 correspond to other embodiments and show modifications of the position of the second antenna element 14, respectively. In an antenna device 15 of an embodiment shown in FIG. 5, a second antenna element 14 is disposed on the same left side of the ground 2 as the previous embodiment. However, a lower end of the left side is defined as a reference position (i.e. zero), and a connection point Gy1 between the second antenna element 14 and the ground 2 satisfies inequalities: 0≤Gy1<λ/8. In FIG. 5, the reference end of the first side and the reference end of the second end are positioned at corners of the ground 2 adjacent to each other.

In an antenna device 16 of an embodiment shown in FIG. 6, a second antenna element 14 is disposed on the right side of the ground 2. An upper end of the right side is defined as a reference position (i.e. zero), and a connection point Gy1 between the second antenna element 14 and the ground 2 satisfies inequalities: 0≤Gy1<λ/8. In FIG. 6, the reference end of the first side and the reference end of the second end are positioned at corners of the ground 2 adjacent to each other. In an antenna device 17 of an embodiment shown in FIG. 7, a second antenna element 14 is disposed on the right side of the ground 2. A lower end of the right side is defined as a reference position (i.e. zero), and a connection point Gy1 between the second antenna element 14 and the ground 2 satisfies inequalities: 0≤Gy1<λ/8. In FIG. 7, the reference end of the first side and the reference end of the second end are positioned at corners of the ground 2 opposite from each other. In any case of the embodiments, similar effects to the previous embodiment can be obtained.

The present disclosure is not limited to the embodiments described above or shown in the drawings and can be modified or expanded as below. The shape of the ground is not limited to the square shape, and may be a rectangular shape. The connection points Gx1 and Gy1 may be less than Gx/2 and Gy/2, respectively. The antenna elements are not limited to the inverted-F antenna elements, and may be inverted-L antenna elements. The number of first folded antenna elements connected to the first side of the ground may be one. The number of second folded antenna elements connected to the second side of the ground may be one.

According to at least one embodiment of the present disclosure, the antenna device includes a ground having a first side and a second side whose lengths Gx and Gy are smaller than or equal to λ/2, and first and second folded antenna elements each having lengths of λ/4 and connected to the first and second sides of the ground at connection points Gx1 and Gy1, respectively. Ends of the first and second sides away from the first and second folded element portions in directions to their first and second folding directions are, respectively, defined as reference, i.e. zero. Gx1 and Gy1 satisfy inequalities: 0≤Gx1<Gx/2 and 0≤Gy1<Gy/2. In other words, the connection points Gx1 and Gy1 are displaced from centers of the first and second sides of the ground in the directions opposite to the second and fourth directions, respectively.

When the antenna device is in communication, and an alternating-current signal flows in the antenna elements, electric current flows in both the element and the side of the ground facing each other. A current flow in the folded element portions of the antenna elements and a current flow in the first or second side of the ground facing the element are opposite to each other and cancel each other out (refer to, for example, the arrows in FIG. 8).

If the antenna element is connected to the center of the side of the ground as in the comparative example, an electric current flows in a portion of the ground which does not face the antenna device. When the side of the ground and the folded element portion of the antenna element are, for example, parallel to the horizontal direction, the current flow in the horizontal portion, of the antenna element may not be cancelled by the current flow in the ground. Therefore, the horizontal portion of the antenna element may cause a radio wave component emitted along a direction inclined at approximately 90-degree angle from the horizontal direction. The radio wave component is combined with a radio wave component which is emitted from the vertical portion, of the antenna element along a direction inclined at approximately 0-degree angle from the horizontal direction. As a result, the combined radio wave is emitted along a direction inclined at approximately 45-degree angle from the horizontal direction. Since a vertical-horizontal relationship is inverse for another side of the ground perpendicular to the side, the main beam is inclined similarly. Therefore, the directions of the main beams of the two antenna elements disposed on the first and second sides that are perpendicular to each other are almost parallel to each other.

In the present disclosure, in contrast, the connection points Gx1 and Gy1 between the ground and the first and second folded antenna elements are displaced from the centers of the first and second side of the ground toward the reference end, which means 0≤Gx1<Gx/2 and 0≤Gy1<Gy/2. Accordingly, current flows in the folded element portions facing the respective sides of the ground can be cancelled out by current flows in the ground. Thus, for example, with respect to the first folded antenna element disposed on the first side parallel to the horizontal direction, the radio wave component emitted along the direction inclined at approximately 90-degree angle from the horizontal direction can be reduced, and an angle between the direction of main beam of the first folded antenna element and the horizontal direction can be reduced. Also, with respect to the second folded antenna element disposed on the second side parallel to the vertical direction, the radio wave component emitted along the direction inclined at approximately 90-degree angle from the vertical direction can be reduced, and an angle between the direction of main beam of the second folded antenna element and the vertical direction can be reduced. As a result, the main beams of the first and second folded antenna elements can be separated without combining with each other, and can be kept to be perpendicular to each other.

The connection points Gx1 and Gy1 may satisfy inequalities: 0≤Gx1<Gx/4 and 0≤Gy1<Gy/4. In this case, the main beams of the first and second folded antenna elements can be made to be closer to a condition perpendicular to each other.

The connection points Gx1 and Gy1 may be zero, i.e. located at the reference positions, at the ends of the respective sides of the ground. In this case, the main beams of the first and second folded antenna elements can be made to be much closer to the condition perpendicular to each other. The ground may have a square shape.

According to a ground connection structure of an antenna device of at least one embodiment of the present disclosure, the antenna device includes first and second folded antenna elements having lengths of λ/4. The first and second folded antenna elements are connected to first and second sides having lengths of Gx and Gy at positions Gx1 and Gy1, respectively. When an end of the first side away from the position Gx1 in a direction opposite from an extending direction of a folded part of the first folded antenna element is defined as a reference (i.e. zero), Gx1 satisfies an inequality: 0≤Gx1<Gx/2. When an end of the second side away from the position Gy1 in a direction opposite from an extending direction of a folded part of the second folded antenna element is defined as a reference (i.e. zero), Gy1 satisfies an inequality: 0≤Gy1<Gy/2. When an alternating current flows in the antenna element during communication of the antenna device, a current flow is generated in a side of the ground facing the antenna elements. The current flow in the folded part of the antenna element is opposite in direction to and cancelled out by the current flow in the side of the ground (refer to arrows in FIG. 8, for example).

Further, when a circuit ground larger in area than the ground of the antenna device is connected to the ground of the antenna device, the connection structure described below is used. The circuit ground has a rectangular shape. One of the first and second sides of the antenna ground is set as an upper side, and a short side of the circuit ground is set as an upper side. These upper sides are aligned at the same height. A long side of the circuit side faces the antenna ground. A connecter extends from a lower side of the circuit ground, and extends parallel to a lower side of the antenna ground. The connector is connected to a center part of the lower side of the antenna ground.

In this case, an influence of a component of current flowing in or out of the ground of the antenna device on a current distribution in the antenna device can be reduced as much as possible. Therefore, change in directivity of the antenna device can be reduced while separation of the first and second elements is maintained.

While the present disclosure has been described with reference to various exemplary embodiments thereof, it is to be understood that the disclosure is not limited to the disclosed embodiments and constructions. To the contrary, the disclosure is intended to cover various modifications and equivalent arrangements. In addition, while the various elements of the disclosure are shown in various combinations and configurations, which are exemplary, other various combinations and configurations, including more, less or only a single element, are also within the spirit of the disclosure.

What is claimed is:

1. An antenna device comprising:
a ground having a first side which has a length Gx, and a second side which has a length Gy and is perpendicular to the first side, each of the lengths Gx and Gy being smaller than or equal to λ/2 when a signal wavelength is defined as λ, and
a first folded antenna element connected to the first side of the ground at a first connection point and having a first folded element portion folded in a first folding direction,
a second folded antenna element connected to the second side of the ground at a second connection point and having a second folded element portion folded in a second folding direction, wherein
Gx1 is defined as a length of a portion of the first side between the first connection point and an end of the first side away from the first folded element portion in a direction opposite to the first folding direction, and the length Gx1 satisfies inequalities: 0≤Gx1<Gx/2, and
Gy1 is defined as a length of a portion of the second side between the second connection point and an end of the second side away from the second folded element portion in a direction opposite to the second folding direction, and the length Gy1 satisfies inequalities: 0≤Gy1<Gy/2.

2. The antenna device according to claim 1, wherein the lengths Gx1 and Gy1 satisfy inequalities: 0≤Gx1<Gx/4 and 0≤Gy1<Gy/4.

3. The antenna device according to claim 2, wherein the lengths Gx1 and Gy1 satisfy equalities: Gx1=Gy1=0.

4. The antenna device according to claim 1, wherein the ground has a square shape.

5. A ground connection structure comprising:
an antenna device including:
an antenna ground having a first side which has a length Gx, and a second side which has a length Gy and is perpendicular to the first side, each of the lengths Gx and Gy being smaller than or equal to λ/2 when a signal wavelength is defined as λ, and
a first folded antenna element connected to the first side of the antenna ground at a first connection point and having a first folded element portion folded in a first folding direction,
a second folded antenna element connected to the second side of the antenna ground at a second connection point and having a second folded element portion folded in a second folding direction,
a circuit ground, and
a connector connecting the antenna ground and the circuit ground, wherein
Gx1 is defined as a length of a portion of the first side between the first connection point and an end of the first side away from the first folded element portion in a direction opposite to the first folding direction, and the length Gx1 satisfies inequalities: 0≤Gx1<Gx/2,
Gy1 is defined as a length of a portion of the second side between the second connection point and an end of the second side away from the second folded element portion in a direction opposite to the second folding direction, and the length Gy1 satisfies inequalities: 0≤Gy1<Gy/2,
the circuit ground has a rectangular shape having a short side and a long side, and the short side and one of the first and second sides are aligned while the long side faces the antenna ground, and
the connector extends from a side of the circuit ground opposite from the short side, extends parallel to a third side of the antenna ground opposite from the one of the first and second sides, and is connected to a center part of the third side of the antenna ground.

6. The ground connection structure according to claim 5, wherein the lengths Gx1 and Gy1 satisfy inequalities: 0≤Gx1<Gx/4 and 0≤Gy1<Gy/4.

7. The ground connection structure according to claim 6, wherein the lengths Gx1 and Gy1 satisfy equalities: Gx1=Gy1=0.

8. The ground connection structure according to claim 5, wherein the antenna ground has a square shape.

9. A ground connection structure comprising:
an antenna device including:
an antenna ground having a first side which has a length Gx, and a second side which has a length Gy and is perpendicular to the first side, each of the lengths Gx and Gy being smaller than or equal to λ/2 when a signal wavelength is defined as λ, and
a first folded antenna element connected to the first side of the antenna ground,
a second folded antenna element connected to the second side of the antenna ground,
a circuit ground, and
a connector connecting the antenna ground and the circuit ground, wherein
the connector extends from a part of the circuit ground that does not face the antenna ground, and is connected to a center part of a third side of the antenna ground opposite from one of the first and second sides of the antenna ground.

10. The ground connection structure according to claim 9, wherein the connector extends parallel to the third side of the antenna ground.

11. The ground connection structure according to claim 9, wherein the circuit ground has a rectangular shape having a short side and a long side, and the short side and the one of the first and second sides are aligned while the long side faces the antenna ground.

12. The antenna device according to claim 1, wherein a number of first folded antenna elements connected to the first side of the antenna ground is one.

13. The antenna device according to claim 12, wherein a number of second folded antenna elements connected to the second side of the antenna ground is one.

14. The antenna device according to claim 1, wherein the end of the first side and the end of the second side are located at the same corner of the ground.

15. The antenna device according to claim 1, wherein the end of the first side and the end of the second side are located at corners of the ground adjacent to each other.

16. The antenna device according to claim 1, wherein the end of the first side and the end of the second side are located at corners of the ground opposite from each other.

17. The antenna device according to claim 1, wherein the first folded antenna element has a length of λ/4, and the second folded antenna element has a length of λ/4.

18. The antenna device according to claim 1, wherein the first folded element portion is folded to extend parallel to the first side of the antenna ground.

19. The antenna device according to claim 18, wherein the second folded element portion is folded to extend parallel to the second side of the antenna ground.
